(19) United States
(12) Patent Application Publication
(10) Pub. No.: US 2020/0407510 A1
(43) Pub. Date: Dec. 31, 2020

(54) POSITIVE-TYPE PHOTOSENSITIVE RESIN COMPOSITION AND CURED FILM PREPARED THEREFROM

(71) Applicant: ROHM AND HAAS ELECTRONIC MATERIALS KOREA LTD., Chungcheongnam-do (KR)

(72) Inventors: Yeonok KIM, Gyeonggi-do (KR); Geun HUH, Gyeonggi-do (KR); Ju-Young JUNG, Gyeonggi-do (KR); JinKyu IM, Gyeonggi-do (KR); Ji Ung KIM, Gyeonggi-do (KR)

(21) Appl. No.: 16/879,149

(22) Filed: May 20, 2020

(30) Foreign Application Priority Data
Jun. 28, 2019 (KR) 10-2019-0078178

(51) Int. Cl. C08G 77/06; C08F 220/06; C08F 2/48

(52) U.S. Cl. CPC C08G 77/06; C08K 5/1515; C08F 2/48; C08F 220/06

(57) ABSTRACT

The present invention relates to a positive-type photosensitive resin composition and a cured film prepared therefrom. The positive-type photosensitive resin composition introduces a multifunctional monomer into a positive-type photosensitive resin composition comprising a mixed binder in which a siloxane copolymer is added to an acrylic copolymer, whereby the penetration of a developer into the binder can be facilitated at the time of development of a pre-baked film to increase the solubility in the developer, thereby further enhancing the pattern developability and sensitivity. Further, a cured film prepared from the composition has excellent appearance characteristics without a rough surface of the film and a scum or the like at the bottom of the film during development.

### TECHNICAL FIELD

The present invention relates to a positive-type photosensitive resin composition capable of forming a cured film that is excellent in sensitivity, film retention rate, and appearance characteristics, and a cured film prepared therefrom to be used in a liquid crystal display, an organic EL display, and the like.

### BACKGROUND ART

Generally, a transparent planarization film is formed on a thin film transistor (TFT) substrate for the purpose of insulation to prevent a contact between a transparent electrode and a data line in a liquid crystal display or an organic EL display. Through a transparent pixel electrode positioned near the data line, the aperture ratio of a panel may be increased, and high luminance/resolution may be attained.

In order to form such a transparent planarization film, several processing steps are employed to impart a specific pattern profile, and a positive-type photosensitive resin composition is widely employed in this process since fewer processing steps are required. In particular, as the size of LCD panels increases, there is an increasing demand for positive cured films without stitch mura and lens mura.

In connection with the conventional positive-type photosensitive resin compositions, technologies of using a polysiloxane resin, an acrylic resin, and the like as raw materials have been introduced.

As compared with a polysiloxane resin that is rich in silanol groups, an acrylic resin has a problem that its sensitivity is lower than that of the polysiloxane resin since the content of carboxyl groups involved in development is limited. In order to compensate this, a photosensitive resin composition and a cured film prepared therefrom have been proposed in which a polysiloxane resin and an acrylic resin are employed together, thereby having excellent sensitivity and adhesiveness (see Japanese Patent No. 5,099,140). However, the sensitivity has not yet been improved to a satisfactory level.

### DISCLOSURE OF INVENTION

### Technical Problem

Accordingly, the present invention aims to provide a positive-type photosensitive resin composition in which a multifunctional monomer is introduced to the positive-type photosensitive resin composition that comprises a siloxane copolymer and an acrylic copolymer together, whereby the penetration of a developer into the composition can be facilitated during development to enhance the pattern developability and sensitivity, as well as a cured film having excellent surface characteristics without scum and thermal flowability can be provided, and a cured film prepared therefrom to be used in a liquid crystal display, an organic EL display, and the like.

### Solution to Problem

In order to accomplish the above object, the present invention provides a positive-type photosensitive resin composition, which comprises (A) an acrylic copolymer; (B) a siloxane copolymer; (C) a 1,2-quinonediazide compound; (D) a multifunctional monomer; and (E) a solvent.

In order to accomplish another object, the present invention provides a cured film formed from the positive-type photosensitive resin composition.

### Advantageous Effects of Invention

The positive-type photosensitive resin composition according to the present invention introduces a multifunctional monomer into a positive-type photosensitive resin composition comprising a mixed binder in which a siloxane copolymer is added to an acrylic copolymer, whereby the penetration of a developer into the binder can be facilitated at the time of development of a pre-baked film to increase the solubility in the developer, thereby further enhancing the pattern developability and sensitivity. In addition, a cured film with little thermal flowability can be obtained if the composition is used. Further, a cured film prepared from the composition has excellent appearance characteristics without a rough surface of the film and scum or the like at the bottom of the film during development.

### BRIEF DESCRIPTION OF DRAWINGS

FIG. 1 a photograph of the surface of a cured film of Example 1 obtained by a scanning electron microscope.

FIG. 2 a photograph of the surface of a cured film of Comparative Example 1 obtained by a scanning electron microscope.

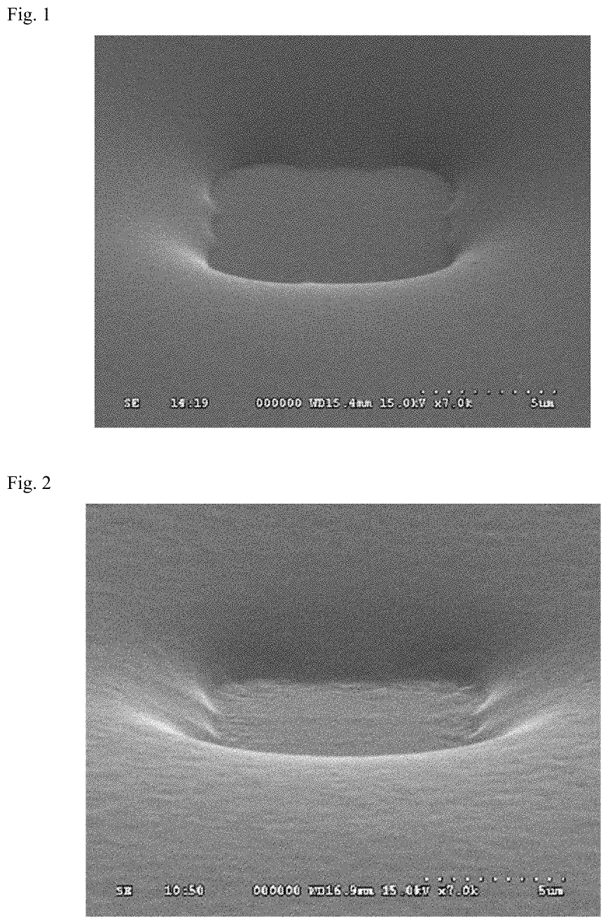

### BEST MODE FOR CARRYING OUT THE INVENTION

The present invention is not limited to those described below. Rather, it can be modified into various forms as long as the gist of the invention is not altered.

Throughout the present specification, when a part is referred to as “comprising” an element, it is understood that other elements may be comprised, rather than other elements are excluded, unless specifically stated otherwise. In addition, all numbers and expressions relating to quantities of components, reaction conditions, and the like used herein are to be understood as being modified by the term “about” unless specifically stated otherwise.

The present invention provides a positive-type photosensitive resin composition, which comprises (A) an acrylic copolymer; (B) a siloxane copolymer; (C) a 1,2-quinonediazide compound; (D) a multifunctional monomer; and (E) a solvent.

It may optionally further comprise (F) an epoxy compound; (G) a surfactant; (H) an adhesion supplement; and/or (I) a silane compound.

As used herein, the term “(meth)acryl” refers to “acryl” and/or “methacryl,” and the term “(meth)acrylate” refers to “acrylate” and/or “methacrylate.”

The weight average molecular weight (g/mole or Da) of each component as described below is measured by gel permeation chromatography (GPC, eluent: tetrahydrofuran) referenced to a polystyrene standard.

(A) Acrylic Copolymer

The positive-type photosensitive resin composition according to the present invention may comprise an acrylic copolymer (A) as a binder.

The acrylic copolymer may comprise (a-1) a structural unit derived from an ethylenically unsaturated carboxylic acid, an ethylenically unsaturated carboxylic anhydride, or a combination thereof; (a-2) a structural unit derived from an unsaturated compound containing an epoxy group; and (a-3) a structural unit derived from an ethylenically unsaturated compound different from the structural units (a-1) and (a-2).

The acrylic copolymer is an alkali-soluble resin for materializing developability in the development step and also plays the role of a base for forming a film upon coating and a structure for forming a final pattern.

(a-1) Structural Unit Derived from an Ethylenically Unsaturated Carboxylic Acid, an Ethylenically Unsaturated Carboxylic Anhydride, or a Combination Thereof

The structural unit (a-1) may be derived from an ethylenically unsaturated carboxylic acid, an ethylenically unsaturated carboxylic anhydride, or a combination thereof.

The ethylenically unsaturated carboxylic acid, the ethylenically unsaturated carboxylic anhydride, or a combination thereof is a polymerizable unsaturated compound containing at least one carboxyl group in the molecule. It may be at least one selected from an unsaturated monocarboxylic acid such as (meth)acrylic acid, crotonic acid, α-chloroacrylic acid, and cinnamic acid; an unsaturated dicarboxylic acid and an anhydride thereof such as maleic acid, maleic anhydride, fumaric acid, itaconic acid, itaconic anhydride, citraconic acid, citraconic anhydride, and mesaconic acid; an unsaturated polycarboxylic acid having three or more valences and an anhydride thereof; and a mono[(meth)acryloyloxyalkyl] ester of a polycarboxylic acid of divalence or more such as mono(2-(meth)acryloyloxyethyl) succinate, mono(2-(meth)acryloyloxyethyl) phthalate, and the like. But it is not limited thereto. (Meth)acrylic acid among the above is preferable from the viewpoint of developability.

The amount of the structural unit (a-1) may be 5 to 50% by mole, preferably 10 to 40% by mole, based on the total moles of the structural units constituting the acrylic copolymer. Within the above range, it is possible to attain a pattern formation of a film while maintaining favorable developability.

(a-2) Structural Unit Derived from an Unsaturated Compound Containing an Epoxy Group

The structural unit (a-2) may be derived from an unsaturated monomer containing at least one epoxy group.

Particular examples of the unsaturated monomer containing at least one epoxy group may include glycidyl (meth)acrylate, 4-hydroxybutyl acrylate glycidyl ether, 3,4-epoxybutyl (meth)acrylate, 4,5-epoxypentyl (meth)acrylate, 5,6-epoxyhexyl (meth)acrylate, 6,7-epoxyheptyl (meth)acrylate, 2,3-epoxycyclopentyl (meth)acrylate, 3,4-epoxycyclohexyl (meth)acrylate, α-ethyl glycidyl acrylate, α-n-propyl glycidyl acrylate, α-n-butyl glycidyl acrylate, N-(4-(2,3-epoxypropoxy)-3,5-dimethylbenzyl)acrylamide, N-(4-(2,3-epoxypropoxy)-3,5-dimethylphenylpropyl)acrylamide, allyl glycidyl ether, 2-methylallyl glycidyl ether, and a combination thereof.

The amount of the structural unit derived from an unsaturated compound containing at least one epoxy group (a-2) may be 1 to 45% by mole, preferably 3 to 30% by mole, based on the total number of moles of the structural units constituting the acrylic copolymer. Within the above range, the storage stability of the composition may be maintained, and the film retention rate upon post-bake may be advantageously enhanced.

(a-3) Structural Unit Derived from an Ethylenically Unsaturated Compound Different from the Structural Units (a-1) and (a-2)

The structural unit (a-3) may be derived from an ethylenically unsaturated compound different from the structural units (a-1) and (a-2).

The ethylenically unsaturated compound different from the structural units (b-1) and (b-2) may be at least one selected from the group consisting of an ethylenically unsaturated compound having an aromatic ring such as phenyl (meth)acrylate, benzyl (meth)acrylate, 2-phenoxyethyl (meth)acrylate, phenoxy diethylene glycol (meth)acrylate, p-nonylphenoxy polyethylene glycol (meth)acrylate, p-nonylphenoxy polypropylene glycol (meth)acrylate, tribromophenyl (meth)acrylate, styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluoro styrene, chlorostyrene, bromostyrene, iodo styrene, methoxystyrene, ethoxystyrene, propoxystyrene, p-hydroxy-α-methylstyrene, acetylstyrene, vinyl toluene, divinylbenzene, vinylphenol, o-vinylbenzyl methyl ether, m-vinylbenzyl methyl ether, and p-vinylbenzyl methyl ether; an unsaturated carboxylic acid ester such as (meth)acrylate, methyl (meth)acrylate, ethyl (meth)acrylate, butyl (meth)acrylate, dimethylaminoethyl (meth)acrylate, isobutyl (meth)acrylate, t-butyl (meth)acrylate, cyclohexyl (meth)acrylate, ethylhexyl (meth)acrylate, tetrahydrofurfuryl (meth)acrylate, hydroxyethyl (meth)acrylate, 2-hydroxypropyl (meth)acrylate, 2-hydroxy-3-chloropropyl (meth)acrylate, 4-hydroxybutyl (meth)acrylate, glycerol (meth)acrylate, methyl α-hydroxymethylacrylate, ethyl α-hydroxymethylacrylate, propyl α-hydroxymethylacrylate, butyl α-hydroxymethylacrylate, 2-methoxyethyl (meth)acrylate, 3-methoxybutyl (meth)acrylate, ethoxy diethylene glycol (meth)acrylate, methoxy triethylene glycol (meth)acrylate, methoxy tripropylene glycol (meth)acrylate, poly(ethylene glycol) methyl ether (meth)acrylate, tetrafluoropropyl (meth)acrylate, 1,1,1,3,3,3-hexafluoroisopropyl (meth)acrylate, octafluoropentyl (meth)acrylate, heptadecafluorodecyl (meth)acrylate, isobornyl (meth)acrylate, dicyclopentanyl (meth)acrylate, dicyclopentenyl (meth)acrylate, dicyclopentanyloxyethyl (meth)acrylate, and dicyclopentenyloxyethyl (meth)acrylate; an N-vinyl tertiary amine containing an N-vinyl group such as N-vinyl pyrrolidone, N-vinyl carbazole, and N-vinyl morpholine; an unsaturated ether such as vinyl methyl ether and vinyl ethyl ether; and an unsaturated imide such as N-phenylmaleimide, N-(4-chlorophenyl)maleimide, N-(4-hydroxyphenyl)maleimide, and N-cyclohexylmaleimide.

The structural unit (a-3) may comprise a structural unit (a-3-1) represented by the following Formula 1:

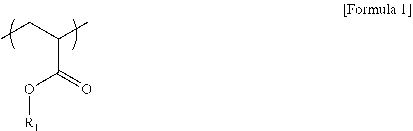

In the above Formula 1, R₁ is C₁₋₄ alkyl.

Specifically, the functional group in the structural unit (a-3-1) can freely rotate in the polymer, which allows the penetration of a developer during the development. Thus, a coating film is more readily developed during the development after the exposure to light, thereby securing excellent sensitivity.

The content of the structural unit (a-3-1) may be 1 to 30% by weight, or 2 to 20% by weight, based on the total weight of the acrylic copolymer (A). Within the above range, it is possible to attain a pattern of a coating film with excellent sensitivity.

The structural unit (a-3) may comprise a structural unit (a-3-2) represented by the following Formula 2:

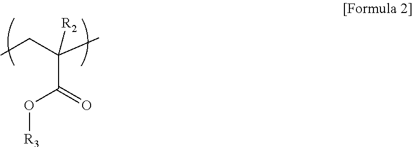

In the above Formula 2, R₂ and R₃ are each independently C₁₋₄ alkyl.

As the acrylic copolymer (A) comprises the structural unit (a-3-1) and the structural unit (a-3-2) at the same time, it is advantageous to improving the sensitivity while maintaining the film retention rate.

The content of the structural unit (a-3-2) may be 1 to 30% by weight, or 2 to 20% by weight, based on the total weight of the acrylic copolymer (A).

The structural unit (a-3-1) and the structural unit (a-3-2) may have a content ratio of 1:99 to 80:20, preferably a content ratio of 5:95 to 40:60. Within the above range, it is advantageous to improving the sensitivity while maintaining the film retention rate.

The amount of the structural unit (a-3) may be 0 to 90% by mole, or 50 to 75% by mole, based on the total number of moles of the structural units constituting the acrylic copolymer (A). Within the above amount range, it is possible to control the reactivity of the acrylic copolymer (i.e., an alkali-soluble resin) and to increase the solubility thereof in an aqueous alkaline solution, so that it is possible to remarkably enhance the coatability of the photosensitive resin composition and to form a pattern on the film with good developability.

The acrylic copolymer may be prepared by compounding each of the compounds that provide the structural units (a-1), (a-2), and (a-3), and adding thereto a molecular weight controlling agent, a polymerization initiator, a solvent, and the like, followed by charging nitrogen thereto and slowly stirring the mixture for polymerization. The molecular weight controlling agent may be a mercaptan compound such as butyl mercaptan, octyl mercaptan, lauryl mercaptan, or the like, or an α-methylstyrene dimer, but it is not particularly limited thereto.

The polymerization initiator may be an azo compound such as 2,2′-azobisisobutyronitrile, 2,2′-azobis(2,4-dimethylvaleronitrile), and 2,2′-azobis(4-methoxy-2,4-dimethylvaleronitrile); or benzoyl peroxide; lauryl peroxide; t-butyl peroxypivalate; 1,1-bis(t-butylperoxy)cyclohexane, or the like, but it is not limited thereto. The polymerization initiator may be used alone or in combination of two or more thereof.

In addition, the solvent may be any solvent commonly used in the preparation of an acrylic copolymer. It may preferably be methyl 3-methoxypropionate (MMP) or propylene glycol monomethyl ether acetate (PGMEA).

In particular, it is possible to reduce the residual amount of unreacted monomers by keeping the reaction time longer while maintaining the reaction conditions to be milder during the polymerization reaction.

The reaction conditions and the reaction time are not particularly limited. For example, the reaction temperature may be adjusted to a temperature lower than the conventional temperature, for example, from room temperature to 60° C. or from room temperature to 65° C. Then, the reaction time is to be maintained until a sufficient reaction takes place.

It is possible to reduce the residual amount of unreacted monomers in the acrylic copolymer to a very minute level when the acrylic copolymer is prepared by the above process.

Here, the term unreacted monomers (or residual monomers) of the acrylic copolymer as used herein refers to the amount of the compounds (i.e., monomers) that aim to provide the structural units (a-1) to (a-3) of the acrylic copolymer, but do not participate in the reaction (i.e., do not form a chain of the copolymer).

Specifically, the amount of unreacted monomers of the acrylic copolymer (A) remaining in the photosensitive resin composition of the present invention may be 2 parts by weight or less, preferably 1 part by weight or less, based on 100 parts by weight of the copolymer (on the basis of solids content).

Here, the term solids content refers to the amount of the composition, exclusive of solvents.

The weight average molecular weight (Mw) of the acrylic copolymer (A) may be in the range of 5,000 to 20,000 Da, preferably 8,000 to 13,000 Da. Within the above range, the adhesiveness to a substrate is excellent, the physical and chemical properties are good, and the viscosity is proper.

The acrylic copolymer (A) may be employed in an amount of 10 to 90% by weight, 30 to 80% by weight, or 45 to 65% by weight, based on the total weight of the photosensitive resin composition on the basis of the solids content, exclusive of solvents. Within the above range, the developability is appropriately controlled, which is advantageous in terms of film retention.

(B) Siloxane Copolymer

The positive-type photosensitive resin composition according to the present invention may comprise a siloxane copolymer as a binder.

The siloxane copolymer has a chemical structure in a complex net shape. The Si—O bond in a siloxane copolymer has a larger decomposition energy than that of the C—C bond in an acrylic copolymer. The siloxane copolymer having such structural characteristics can suppress the thermal flowability of other components having a low molecular weight, such as the linear acrylic copolymer or multifunctional monomer, in the composition when a cured film is formed. In addition, the silanol in the siloxane copolymer improves the binding to the lower substrate, thereby improving the adhesion thereto. It also increases the efficiency of the inhibition with a photoactive compound (PAC), thereby helping to increase the film retention rate.

The siloxane copolymer includes a condensate of a silane compound and/or a hydrolysate thereof. In such event, the silane compound or the hydrolysate thereof may be a monofunctional to tetrafunctional silane compound.

As a result, the siloxane copolymer may comprise a siloxane structural unit selected from the following Q, T, D, and M types:
Q type siloxane structural unit: a siloxane structural unit comprising a silicon atom and four adjacent oxygen atoms, which may be derived from, e.g., a tetrafunctional silane compound or a hydrolysate of a silane compound that has four hydrolyzable groups.
T type siloxane structural unit: a siloxane structural unit comprising a silicon atom and three adjacent oxygen atoms, which may be derived from, e.g., a trifunctional silane compound or a hydrolysate of a silane compound that has three hydrolyzable groups.
D type siloxane structural unit: a siloxane structural unit comprising a silicon atom and two adjacent oxygen atoms (i.e., a linear siloxane structural unit), which may be derived from, e.g., a difunctional silane compound or a hydrolysate of a silane compound that has two hydrolyzable groups.
M type siloxane structural unit: a siloxane structural unit comprising a silicon atom and one adjacent oxygen atom, which may be derived from, e.g., a monofunctional silane compound or a hydrolysate of a silane compound that has one hydrolyzable group.

For example, the siloxane copolymer may comprise a structural unit derived from a compound represented by the following Formula 3. For example, the siloxane copolymer may be a condensate of a silane compound represented by the following Formula 3 and/or a hydrolysate thereof.

(R₄)ₙSi(OR₅)₄₋ₙ [Formula 3]

In the above Formula 3, n is an integer of 0 to 3, R₄ is each independently C₁₋₁₂ alkyl, C₂₋₁₀ alkenyl, C₆₋₁₅ aryl, C₃₋₁₂ heteroalkyl, C₄₋₁₀ heteroalkenyl, or C₆₋₁₅ heteroaryl, and R₅ is each independently hydrogen, C₁₋₆ alkyl, C₂₋₆ acyl, or C₆₋₁₅ aryl, wherein the heteroalkyl, the heteroalkenyl, and the heteroaryl groups each independently have at least one heteroatom selected from the group consisting of O, N, and S.

Examples of the structural unit wherein R₄ has a heteroatom include an ether, an ester, and a sulfide.

The compound may be a tetrafunctional silane compound where n is 0, a trifunctional silane compound where n is 1, a difunctional silane compound where n is 2, or a monofunctional silane compound where n is 3.

Particular examples of the silane compound may include, e.g., as the tetrafunctional silane compound, tetraacetoxysilane, tetramethoxysilane, tetraethoxysilane, tetrabutoxysilane, tetraphenoxysilane, tetrabenzyloxysilane, and tetrapropoxysilane; as the trifunctional silane compound, methyltrichlorosilane, methyltrimethoxysilane, methyltriethoxysilane, methyltriisopropoxysilane, methyltributoxysilane, ethyltrimethoxysilane, ethyltriethoxysilane, ethyltriisopropoxysilane, ethyltributoxysilane, butyltrimethoxysilane, pentafluorophenyltrimethoxysilane, phenyltrimethoxysilane, phenyltriethoxysilane, d³-methyltrimethoxysilane, nonafluorobutylethyltrimethoxysilane, trifluoromethyltrimethoxysilane, n-propyltrimethoxysilane, n-propyltriethoxysilane, n-butyltriethoxysilane, n-hexyltrimethoxysilane, n-hexyltriethoxysilane, decyltrimethoxysilane, vinyltrimethoxysilane, vinyltriethoxysilane, 3-methacryloxypropyltrimethoxysilane, 3-methacryloxypropyltriethoxysilane, 3-acryloxypropyltrimethoxysilane, 3-acryloxypropyltriethoxysilane, p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltriethoxysilane, 3,3,3-trifluoropropyltrimethoxysilane, 3-aminopropyltrimethoxysilane, 3-aminopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, ((3-ethyl-3-oxetanyl)methoxy)propyltrimethoxysilane, ((3-ethyl-3-oxetanyl)methoxy)propyltriethoxysilane, 3-mercaptopropyltrimethoxysilane, and 3-trimethoxysilylpropylsuccinic acid; as the difunctional silane compound, dimethyldiacetoxysilane, dimethyldimethoxysilane, diphenyldimethoxysilane, diphenyldiethoxysilane, diphenyldiphenoxysilane, dibutyldimethoxysilane, dimethyldiethoxysilane, (3-glycidoxypropyl)methyldimethoxysilane, (3-glycidoxypropyl)methyldiethoxysilane, 3-(2-aminoethylamino)propyldimethoxymethylsilane, 3-aminopropyldiethoxymethylsilane, 3-chloropropyldimethoxymethylsilane, 3-mercaptopropyldimethoxymethylsilane, cyclohexyldimethoxymethylsilane, diethoxymethylvinylsilane, dimethoxymethylvinylsilane, and dimethoxydi-p-tolylsilane; and as the monofunctional silane compound, trimethylsilane, tributylsilane, trimethylmethoxysilane, tributylethoxysilane, (3-glycidoxypropyl)dimethylmethoxysilane, and (3-glycidoxypropyl)dimethylethoxysilane.

Preferred among the tetrafunctional silane compounds are tetramethoxysilane, tetraethoxysilane, and tetrabutoxysilane; preferred among the trifunctional silane compounds are methyltrimethoxysilane, methyltriethoxysilane, methyltriisopropoxysilane, methyltributoxysilane, phenyltrimethoxysilane, ethyltrimethoxysilane, ethyltriethoxysilane, ethyltriisopropoxysilane, ethyltributoxysilane, and butyltrimethoxysilane; preferred among the difunctional silane compounds are dimethyldimethoxysilane, diphenyldimethoxysilane, diphenyldiethoxysilane, diphenyldiphenoxysilane, dibutyldimethoxysilane, and dimethyldiethoxysilane.

These silane compounds may be used alone or in combination of two or more thereof.

The conditions for obtaining a hydrolysate or a condensate of the silane compound of the above Formula 3 are not particularly limited. For example, the silane compound of Formula 3 is optionally diluted with a solvent such as ethanol, 2-propanol, acetone, butyl acetate, or the like, and water that is essential for the reaction and an acid (e.g., hydrochloric acid, acetic acid, nitric acid, or the like) or a base (e.g., ammonia, triethylamine, cyclohexylamine, tetramethylammonium hydroxide, or the like) as a catalyst are added thereto, followed by stirring the mixture to complete the hydrolytic polymerization reaction, whereby the desired hydrolysate or condensate thereof can be obtained.

The weight average molecular weight of the condensate (i.e., siloxane copolymer) obtained by the hydrolytic polymerization of the silane compound of the above Formula 3 is preferably in a range of 500 to 50,000 Da. Within the above range, it is more preferable in terms of the film formation characteristics, solubility, dissolution rate to a developer, and the like.

The type and amount of the solvent or the acid or base catalyst are not particularly limited. In addition, the hydrolytic polymerization reaction may be carried out at a low temperature of 20° C. or lower. Alternatively, the reaction may be expedited by heating or refluxing.

The required reaction time may be adjusted depending on the type and concentration of the silane structural units, reaction temperature, and the like. For example, it usually takes 15 minutes to 30 days for the reaction to proceed until the molecular weight of the condensate thus obtained becomes approximately 500 to 50,000 Da. But it is not limited thereto.

The siloxane copolymer may comprise a linear siloxane structural unit (i.e., D-type siloxane structural unit). This linear siloxane structural unit may be derived from a difunctional silane compound, for example, a compound represented by the above Formula 3 where n is 2. Particularly, the siloxane copolymer may comprise the structural unit derived from the silane compound of the above Formula 3 where n is 2 in an amount of 0.5 to 50% by mole, preferably 1 to 30% by mole, based on an Si atomic mole number. Within the above content range, it is possible that a cured film may have flexible characteristics while maintaining a certain level of hardness, whereby the crack resistance to an external stress can be further enhanced.

Further, the siloxane copolymer may comprise a structural unit derived from a silane compound represented by the above Formula 3 where n is 1 (i.e., T-type structural unit). Preferably, the siloxane copolymer may comprise the structural unit derived from the silane compound of the above Formula 3 where n is 1 in an amount ratio of 40 to 85% by mole, more preferably 50 to 80% by mole, based on an Si atomic mole number. Within the above content range, it is more advantageous to form a precise pattern profile.

In addition, in consideration of the hardness, sensitivity, and retention rate of a cured film, it is preferable that the siloxane copolymer comprises a structural unit derived from a silane compound having an aryl group. For example, the siloxane copolymer may comprise the structural unit derived from a silane compound having an aryl group in an amount of 30 to 70% by mole, preferably 35 to 50% by mole, based on an Si atomic mole number. Within the above content range, the compatibility of the siloxane copolymer with a 1,2-naphthoquinonediazide compound is excellent, which may prevent an excessive decrease in sensitivity while attaining more favorable transparency of a cured film. The structural unit derived from the silane compound having an aryl group may be a structural unit derived from a silane compound of the above Formula 3 where R₄ is an aryl group, preferably a silane compound of the above Formula 3 where n is 1 and R₄ is an aryl group, particularly a silane compound of the above Formula 3 where n is 1 and R₄ is a phenyl group (i.e., siloxane structural unit of T-phenyl type).

The siloxane copolymer may comprise a structural unit derived from a silane compound represented by the above Formula 3 where n is 0 (i.e., Q-type structural unit). Preferably, the siloxane copolymer may comprise the structural unit derived from the silane compound represented by the above Formula 3 where n is 0 in an amount of 10 to 40% by mole, preferably 15 to 35% by mole, based on an Si atomic mole number. Within the above content range, the photosensitive resin composition may maintain its solubility to an aqueous alkaline solution at a proper level during the formation of a pattern, thereby preventing any defects caused by a reduction in the solubility or a drastic increase in the solubility of the composition.

The term “% by mole based on an Si atomic molar number” as used herein refers to a percentage of the number of moles of Si atoms contained in a specific structural unit with respect to the total number of moles of Si atoms contained in all of the structural units constituting the siloxane copolymer.

The molar amount of a siloxane unit in the siloxane copolymer may be measured by the combination of Si-NMR, ¹H-NMR, ¹³C-NMR, IR, TOF-MS, elementary analysis, measurement of ash, and the like. For example, in order to measure the molar amount of a siloxane unit having a phenyl group, an Si-NMR analysis is performed on the entire siloxane copolymer, followed by an analysis of the phenyl-bound Si peak area and the phenyl-unbound Si peak area. The molar amount can then be computed from the peak area ratio between them.

Further, if the siloxane copolymer dissolves too rapidly to a developer during development, there arises a problem that the adhesiveness of a pattern is deteriorated due to the rapid developability. If it dissolves too slowly, there is a problem that the sensitivity is lowered.

Therefore, it is important that the siloxane copolymer has an appropriate level of dissolution rate to a developer. Specifically, when the siloxane copolymer is dissolved in an aqueous solution of 1.5% by weight of tetramethylammonium hydroxide solution at a pre-bake temperature of 105° C., it may have an average dissolution rate (ADR) of 50 Å/sec or more, 100 Å/sec or more, 1,500 Å/sec or more, 100 to 10,000 Å/sec, 100 to 8,000 Å/sec, 100 to 5,000 Å/sec, 1,000 to 5,000 Å/sec, or 1,500 to 5,000 Å/sec. Within the above range, it is more advantageous in terms of sensitivity and resolution upon development.

The photosensitive resin composition may comprise the siloxane copolymer in an amount of 20 to 80 parts by weight, or 30 to 60 parts by weight, based on 100 parts by weight of the acrylic copolymer (A) (on the basis of solids content excluding solvents). Within the above range, the developability is appropriately controlled, which is advantageous in terms of film retention and resolution.

(C) 1,2-Quinonediazide Compound

The positive-type photosensitive resin composition according to the present invention may comprise a 1,2-quinonediazide-based compound (C).

The 1,2-quinonediazide-based compound may be a compound used as a photosensitive agent in the photoresist field.

Examples of the 1,2-quinonediazide-based compound include an ester of a phenolic compound and 1,2-benzoquinonediazide-4-sulfonic acid or 1,2-benzoquinonediazide-5-sulfonic acid; an ester of a phenolic compound and 1,2-naphthoquinonediazide-4-sulfonic acid or 1,2-naphthoquinonediazide-5-sulfonic acid; a sulfonamide of a phenolic compound in which the hydroxyl group is substituted with an amino group and 1,2-benzoquinonediazide-4-sulfonic acid or 1,2-benzoquinonediazide-5-sulfonic acid; a sulfonamide of a phenolic compound in which the hydroxyl group is substituted with an amino group and 1,2-naphthoquinonediazide-4-sulfonic acid or 1,2-naphthoquinonediazide-5-sulfonic acid. The above compounds may be used alone or in combination of two or more thereof.

Here, examples of the phenolic compound include 2,3,4-trihydroxybenzophenone, 2,4,6-trihydroxybenzophenone, 2,2′,4,4′-tetrahydroxybenzophenone, 2,3,3′,4-tetrahydroxybenzophenone, 2,3,4,4′-tetrahydroxybenzophenone, bis(2,4-dihydroxyphenyl)methane, bis(p-hydroxyphenyl)methane, tri(p-hydroxyphenyl)methane, 1,1,1-tri(p-hydroxyphenyl)ethane, bis(2,3,4-trihydroxyphenyl)methane, 2,2-bis(2,3,4-trihydroxyphenyl)propane, 1,1,3-tris(2,5-dimethyl-4-hydroxyphenyl)-3-phenylpropane, 4,4′-(1-(4-(1-(4-hydroxyphenyl)-1-methylethyl)phenyl)ethylidene)bisphenol, bis(2,5-dimethyl-4-hydroxyphenyl)-2-hydroxyphenylmethane, 3,3,3′,3′-tetramethyl-1,1′-spirobiindene-5,6,7,5′,6′,7′-hexanol, 2,2,4-trimethyl-7,2′,4′-trihydroxyflavane, and the like.

More particular examples of the 1,2-quinonediazide-based compound include an ester of 2,3,4-trihydroxybenzophenone and 1,2-naphthoquinonediazide-4-sulfonic acid, an ester of 2,3,4-trihydroxybenzophenone and 1,2-naphthoquinonediazide-5-sulfonic acid, an ester of 4,4′-(1-(4-(1-(4-hydroxyphenyl)-1-methylethyl]phenyl)ethylidene)bisphenol and 1,2-naphthoquinonediazide-4-sulfonic acid, an ester of 4,4′-(1-(4-(1-(4-hydroxyphenyl)-1-methylethyl)phenyl)ethylidene)bisphenol and 1,2-naphthoquinonediazide-5-sulfonic acid, and the like.

The above compounds may be used alone or in combination of two or more thereof.

If the preferable compounds exemplified above are used, the transparency of the photosensitive resin composition may be enhanced.

The photosensitive resin composition may comprise the 1,2-quinonediazide-based compound in an amount of 2 to 50 parts by weight, or 5 to 30 parts by weight, based on 100 parts by weight of the acrylic copolymer (A) (on the basis of solids content excluding solvents). Within the above content range, a pattern is more readily formed, and it is possible to prevent such defects as a rough surface of a coated film upon the formation thereof and such a pattern shape as scum appearing at the bottom portion of the pattern upon development, and to secure excellent transmittance.

(D) Multifunctional Monomer

The positive-type photosensitive resin composition according to the present invention may comprise a multifunctional monomer (D).

The multifunctional monomer is a monomer having a small molecular weight and a double bond. Specifically, it may comprise at least one ethylenically unsaturated double bond. More specifically, the multifunctional monomer may comprise a monofunctional or multifunctional ester compound having at least one ethylenically unsaturated double bond. It may preferably be a tri- to octa-functional compound from the viewpoint of developability.

The multifunctional monomer may be at least one selected from the group consisting of ethylene glycol di(meth)acrylate, propylene glycol di(meth)acrylate, diethylene glycol di(meth)acrylate, triethylene glycol di(meth)acrylate, 1,6-hexanediol di(meth)acrylate, polyethylene glycol di(meth)acrylate, polypropylene glycol di(meth)acrylate, glycerin tri(meth)acrylate, trimethylolpropane tri(meth)acrylate, pentaerythritol tri(meth)acrylate, a monoester of pentaerythritol tri(meth)acrylate and succinic acid, pentaerythritol tetra(meth)acrylate, dipentaerythritol penta(meth)acrylate, dipentaerythritol hexa(meth)acrylate, a monoester of dipentaerythritol penta(meth)acrylate and succinic acid, caprolactone-modified dipentaerythritol hexa(meth)acrylate, pentaerythritol triacrylate-hexamethylene diisocyanate (a reaction product of pentaerythritol triacrylate and hexamethylene diisocyanate), tripentaerythritol hepta(meth)acrylate, tripentaerythritol octa(meth)acrylate, and ethylene glycol monomethyl ether acrylate.

Examples of a commercially available multifunctional monomer may include (i) monofunctional (meth)acrylate such as Aronix M-101, M-111, and M-114 manufactured by Toagosei Co., Ltd., KAYARAD T4-110S and T4-120S manufactured by Nippon Kayaku Co., Ltd., and V-158 and V-2311 manufactured by Osaka Yuki Kayaku Kogyo Co., Ltd.; (ii) bifunctional (meth)acrylate such as Aronix M-210, M-240, and M-6200 manufactured by Toagosei Co., Ltd., KAYARAD HDDA, HX-220, and R-604 manufactured by Nippon Kayaku Co., Ltd., and V-260, V-312, and V-335 HP manufactured by Osaka Yuki Kayaku Kogyo Co., Ltd.; and (iii) tri and more functional (meth)acrylate such as Aronix M-309, M-400, M-403, M-405, M-450, M-7100, M-8030, M-8060, and TO-1382 manufactured by Toagosei Co., Ltd., KAYARAD TMPTA, DPHA, DPHA-40H, T-1420, DPCA-20, DPCA-30, DPCA-60, and DPCA-120 manufactured by Nippon Kayaku Co., Ltd., and V-295, V-300, V-360, V-GPT, V-3PA, V-400, and V-802 manufactured by Osaka Yuki Kayaku Kogyo Co., Ltd.

The multifunctional monomer is in general mainly used in the negative type. In the negative type, it acts as a crosslink by light during exposure to light. On the other hand, in the positive type of the present invention, it acts to improve the developability, thereby enhancing the sensitivity, to provide excellent surface characteristics, and to remove scum.

Specifically, the multifunctional monomer may have a relatively small molecular weight as compared with the binder (i.e., the acrylic copolymer (A) and the siloxane copolymer (B)). The multifunctional monomer, which has a relatively small molecular weight as compared with the binder, is present between the binder to facilitate the penetration of a developer to the pre-baked film during development, thereby improving the sensitivity. In addition, as a result, it is possible to secure excellent surface characteristics and to suppress scum as the developability near the holes is increased.

The photosensitive resin composition may comprise the multifunctional monomer in an amount of 1 to 30 parts by weight, or 3 to 20 parts by weight, based on 100 parts by weight of the acrylic copolymer (A) (on the basis of solids content excluding solvents).

Within the above range, the developability can be properly adjusted to secure excellent sensitivity, the surface of a coating film is not rough upon the formation of the coating film, and scum does not occur at the bottom of the film during development. If it is used in an amount smaller than the above range, the sensitivity is not sufficiently enhanced. If it is excessively used, the thermal flowability in the composition is increased during the hard-bake, whereby the resolution of a pattern is deteriorated.

(E) Solvent

The positive-type photosensitive resin composition of the present invention may be prepared in the form of a liquid composition in which the above components are mixed with a solvent. The solvent may be, for example, an organic solvent.

The amount of the solvent in the positive-type photosensitive resin composition according to the present invention is not particularly limited. For example, the solvent may be employed such that the solids content is 10 to 70% by weight, or 15 to 60% by weight, based on the total weight of the composition.

The term solids content refers to the components that constitute the composition, exclusive of solvents. If the amount of the solvent is within the above range, the coating of the composition can be readily carried out, and the flowability thereof can be maintained at a proper level.

The solvent of the present invention is not particularly limited as long as it can dissolve the above-mentioned components and is chemically stable. For example, the solvent may be alcohols, ethers, glycol ethers, ethylene glycol alkyl ether acetates, diethylene glycol, propylene glycol monoalkyl ethers, propylene glycol alkyl ether acetates, propylene glycol alkyl ether propionates, aromatic hydrocarbons, ketones, esters, or the like.

Particular examples of the solvent include methanol, ethanol, tetrahydrofuran, dioxane, methyl cellosolve acetate, ethyl cellosolve acetate, ethyl acetoacetate, ethylene glycol monomethyl ether, ethylene glycol monoethyl ether, ethylene glycol dimethyl ether, ethylene glycol diethyl ether, propylene glycol dimethyl ether, propylene glycol diethyl ether, diethylene glycol monomethyl ether, diethylene glycol monoethyl ether, diethylene glycol dimethyl ether, diethylene glycol ethyl methyl ether, propylene glycol monomethyl ether, propylene glycol monoethyl ether, propylene glycol monopropyl ether, dipropylene glycol dimethyl ether, dipropylene glycol diethyl ether, propylene glycol methyl ether acetate, propylene glycol ethyl ether acetate, propylene glycol propyl ether acetate, dipropylene glycol methyl ether acetate, propylene glycol butyl ether acetate, toluene, xylene, methyl ethyl ketone, 4-hydroxy-4-methyl-2-pentanone, cyclopentanone, cyclohexanone, 2-heptanone, γ-butyrolactone, ethyl 2-hydroxypropionate, ethyl 2-hydroxy-2-methylpropionate, ethyl ethoxyacetate, ethyl hydroxyacetate, methyl 2-hydroxy-3-methylbutanoate, methyl 2-methoxypropionate, methyl 3-methoxypropionate, ethyl 3-methoxypropionate, ethyl 3-ethoxypropionate, methyl 3-ethoxypropionate, methyl pyruvate, ethyl pyruvate, ethyl acetate, butyl acetate, ethyl lactate, butyl lactate, N,N-dimethylformamide, N,N-dimethylacetamide, N-methylpyrrolidone, and the like.

Preferred among the above are ethylene glycol alkyl ether acetates, diethylene glycols, propylene glycol monoalkyl ethers, propylene glycol alkyl ether acetates, ketones, and the like. In particular, preferred are diethylene glycol dimethyl ether, diethylene glycol ethyl methyl ether, dipropylene glycol dimethyl ether, dipropylene glycol diethyl ether, propylene glycol monomethyl ether, propylene glycol monoethyl ether, propylene glycol methyl ether acetate, methyl 3-methoxypropionate, γ-butyrolactone, 4-hydroxy-4-methyl-2-pentanone, and the like.

The solvents exemplified above may be used alone or in combination of two or more thereof.

(F) Epoxy Compound

The positive-type photosensitive resin composition according to the present invention may further comprise an epoxy compound. The epoxy compound may increase the internal density of the binder, particularly the siloxane copolymer, to thereby enhance the chemical resistance of a cured film formed therefrom.

The epoxy compound may be a homo-oligomer or a hetero-oligomer of an unsaturated monomer containing at least one epoxy group.

Examples of the unsaturated monomer containing at least one epoxy group may include glycidyl (meth)acrylate, 4-hydroxybutylacrylate glycidyl ether, 3,4-epoxybutyl (meth)acrylate, 4,5-epoxypentyl (meth)acrylate, 5,6-epoxyhexyl (meth)acrylate, 6,7-epoxyheptyl (meth)acrylate, 2,3-epoxycyclopentyl (meth)acrylate, 3,4-epoxycyclohexyl (meth)acrylate, α-ethyl glycidyl acrylate, α-n-propyl glycidyl acrylate, α-n-butyl glycidyl acrylate, N-(4-(2,3-epoxypropoxy)-3,5-dimethylbenzyl)acrylamide, N-(4-(2,3-epoxypropoxy)-3,5-dimethylphenylpropyl)acrylamide, allyl glycidyl ether, 2-methylallyl glycidyl ether, o-vinylbenzyl glycidyl ether, m-vinylbenzyl glycidyl ether, p-vinylbenzyl glycidyl ether, and a mixture thereof.

The epoxy compound may be synthesized by any methods well known in the art.

Examples of the epoxy compound may include glycidyl methacrylate homopolymer and 3,4-epoxycyclohexylmethyl methacrylate homopolymer.

The epoxy compound may further comprise the following structural unit.

Particular examples thereof may include any structural unit derived from styrene; a styrene having an alkyl substituent such as methylstyrene, dimethylstyrene, trimethylstyrene, ethylstyrene, diethylstyrene, triethylstyrene, propylstyrene, butylstyrene, hexylstyrene, heptylstyrene, and octylstyrene; a styrene having a halogen such as fluorostyrene, chlorostyrene, bromostyrene, and iodostyrene; a styrene having an alkoxy substituent such as methoxystyrene, ethoxystyrene, and propoxystyrene; an acetylstyrene such as p-hydroxy-α-methylstyrene; an ethylenically unsaturated compound having an aromatic ring such as divinylbenzene, vinylphenol, o-vinylbenzyl methyl ether, m-vinylbenzyl methyl ether, and p-vinylbenzyl methyl ether; an unsaturated carboxylic acid ester such as methyl (meth)acrylate, ethyl (meth)acrylate, butyl (meth)acrylate, dimethylaminoethyl (meth)acrylate, isobutyl (meth)acrylate, t-butyl (meth)acrylate, cyclohexyl (meth)acrylate, ethylhexyl (meth)acrylate, tetrahydrofurfuryl (meth)acrylate, hydroxyethyl (meth)acrylate, 2-hydroxypropyl (meth)acrylate, 2-hydroxy-3-chloropropyl (meth)acrylate, 4-hydroxybutyl (meth)acrylate, glycerol (meth)acrylate, methyl α-hydroxymethylacrylate, ethyl α-hydroxymethylacrylate, propyl α-hydroxymethylacrylate, butyl α-hydroxymethylacrylate, 2-methoxyethyl (meth)acrylate, 3-methoxybutyl (meth)acrylate, ethoxy diethylene glycol (meth)acrylate, methoxy triethylene glycol (meth)acrylate, methoxy tripropylene glycol (meth)acrylate, poly(ethylene glycol) methyl ether (meth)acrylate, phenyl (meth)acrylate, benzyl (meth)acrylate, 2-phenoxyethyl (meth)acrylate, phenoxy diethylene glycol (meth)acrylate, p-nonylphenoxy polyethylene glycol (meth)acrylate, p-nonylphenoxy polypropylene glycol (meth)acrylate, tetrafluoropropyl (meth)acrylate, 1,1,1,3,3,3-hexafluoroisopropyl (meth)acrylate, octafluoropentyl (meth)acrylate, heptadecafluorodecyl (meth)acrylate, tribromophenyl (meth)acrylate, isobornyl (meth)acrylate, dicyclopentanyl (meth)acrylate, dicyclopentenyl (meth)acrylate, dicyclopentanyloxyethyl (meth)acrylate, and dicyclopentenyloxyethyl (meth)acrylate; a tertiary amine having an N-vinyl group such as N-vinyl pyrrolidone, N-vinyl carbazole, and N-vinyl morpholine; an unsaturated ether such as vinyl methyl ether and vinyl ethyl ether; an unsaturated imide such as N-phenylmaleimide, N-(4-chlorophenyl)maleimide, N-(4-hydroxyphenyl)maleimide, and N-cyclohexylmaleimide. The structural unit derived from the compounds exemplified above may be contained in the epoxy compound alone or in combination of two or more thereof.

The styrene-based compounds among the above compounds may be further preferable in consideration of polymerizability.

In particular, it is more preferable in terms of the chemical resistance that the epoxy compound does not contain a carboxyl group by way of not using a structural unit derived from a monomer containing a carboxyl group among the above.

The structural unit may be employed in an amount of 0 to 70% by mole, preferably 10 to 60% by mole, based on the total number of moles of the structural units constituting the epoxy compound. Within the above content range, it may be more advantageous in terms of the film strength.

The weight average molecular weight of the epoxy compound may preferably be 100 to 30,000 Da. The weight average molecular weight thereof may more preferably be 1,000 to 15,000 Da. If the weight average molecular weight of the epoxy compound is at least 100 Da, the hardness of a cured film may be more favorable. If it is 30,000 Da or less, a cured film may have a uniform thickness, which is suitable for planarizing any steps thereon.

The photosensitive resin composition may comprise the epoxy compound in an amount of 1 to 40 parts by weight, or 4 to 25 parts by weight, based on 100 parts by weight of the acrylic copolymer (A) (on the basis of solids content excluding solvents). Within the above content range, the chemical resistance and adhesiveness may be more favorable.

(G) Surfactant

The positive-type photosensitive resin composition according to the present invention may further comprise a surfactant to enhance its coatability, if desired.

The kind of the surfactant is not particularly limited, but examples thereof include fluorine-based surfactants, silicon-based surfactants, non-ionic surfactants, and the like.

Specific examples of the surfactant may include fluorine- and silicon-based surfactants such as FZ-2122 supplied by Dow Corning Toray Co., Ltd., BM-1000 and BM-1100 supplied by BM CHEMIE Co., Ltd., Megapack F-142 D, F-172, F-173, and F-183 supplied by Dai Nippon Ink Chemical Kogyo Co., Ltd., Florad FC-135, FC-170 C, FC-430, and FC-431 supplied by Sumitomo 3M Ltd., Sufron S-112, S-113, S-131, S-141, S-145, S-382, SC-101, SC-102, SC-103, SC-104, SC-105, and SC-106 supplied by Asahi Glass Co., Ltd., Eftop EF301, EF303, and EF352 supplied by Shinakida Kasei Co., Ltd., SH-28 PA, SH-190, SH-193, SZ-6032, SF-8428, DC-57, and DC-190 supplied by Toray Silicon Co., Ltd.; non-ionic surfactants such as polyoxyethylene alkyl ethers including polyoxyethylene lauryl ether, polyoxyethylene stearyl ether, polyoxyethylene oleyl ether, and the like; polyoxyethylene aryl ethers including polyoxyethylene octylphenyl ether, polyoxyethylene nonylphenyl ether, and the like; and polyoxyethylene dialkyl esters including polyoxyethylene dilaurate, polyoxyethylene distearate, and the like; and organosiloxane polymer KP341 (manufactured by Shin-Etsu Chemical Co., Ltd.), (meth)acrylate-based copolymer Polyflow Nos. 57 and 95 (manufactured by Kyoei Yuji Chemical Co., Ltd.), and the like. They may be used alone or in combination of two or more thereof.

The photosensitive resin composition may comprise the surfactant in an amount of 0.001 to 5 parts by weight, or 0.05 to 2 parts by weight, based on 100 parts by weight of the acrylic copolymer (A) (on the basis of solids content excluding solvents). Within the above content range, the coating and leveling characteristics of the composition may be good.

(H) Adhesion Supplement

The positive-type photosensitive resin composition according to the present invention may further comprise an adhesion supplement to enhance the adhesiveness to a substrate.

The adhesion supplement may have at least one reactive group selected from the group consisting of a carboxyl group, a (meth)acryloyl group, an isocyanate group, an amino group, a mercapto group, a vinyl group, and an epoxy group.

The kind of the adhesion supplement is not particularly limited. It may be at least one selected from the group consisting of trimethoxysilyl benzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, γ-glycidoxypropyltriethoxysilane, N-phenylaminopropyltrimethoxysilane, and β-(3,4-epoxycyclohexyl)ethyltrimethoxysilane.

Preferred is γ-glycidoxypropyltrimethoxysilane, γ-glycidoxypropyltriethoxysilane, 3-isocyanate propyl triethoxysilane, or N-phenylaminopropyltrimethoxysilane, which is capable of enhancing the film retention rate and the adhesiveness to a substrate.

The photosensitive resin composition may comprise the adhesion supplement in an amount of 0 to 5 parts by weight, or 0.001 to 2 parts by weight, based on 100 parts by weight of the acrylic copolymer (A) (on the basis of solids content excluding solvents). Within the above content range, the adhesiveness to a substrate may be further enhanced.

(I) Silane Compound

The positive-type photosensitive resin composition of the present invention may comprise at least one silane compound represented by the following Formula 4, particularly, silane monomers of T type and/or Q type, to thereby enhance the chemical resistance during the treatment in the post-processing by reducing highly reactive silanol groups (Si—OH) in the siloxane copolymer, in association with the epoxy compound, for instance, epoxy oligomers.

(R₆)ₙSi(OR₇)₄₋ₙ [Formula 4]

in the above Formula 4, n is an integer of 0 to 3, R₆ is each independently C₁₋₁₂ alkyl, C₂₋₁₀ alkenyl, C₆₋₁₅ aryl, C₃₋₁₂ heteroalkyl, C₄₋₁₀ heteroalkenyl, or C₆₋₁₅ heteroaryl, and R₇ is each independently hydrogen, C₁₋₆ alkyl, C₂₋₆ acyl, or C₆₋₁₅ aryl, wherein the heteroalkyl, the heteroalkenyl, and the heteroaryl groups each independently have at least one heteroatom selected from the group consisting of O, N, and S.

Examples of the structural unit wherein R₆ has a heteroatom include an ether, an ester, and a sulfide.

According to the present invention, the compound may be a tetrafunctional silane compound where n is 0, a trifunctional silane compound where n is 1, a difunctional silane compound where n is 2, or a monofunctional silane compound where n is 3.

Particular examples of the silane compound may include, e.g., as the tetrafunctional silane compound, tetraacetoxysilane, tetramethoxysilane, tetraethoxysilane, tetrabutoxysilane, tetraphenoxysilane, tetrabenzyloxysilane, and tetrapropoxysilane; as the trifunctional silane compound, methyltrimethoxysilane, methyltriethoxysilane, methyltriisopropoxysilane, methyltributoxysilane, ethyltrimethoxysilane, ethyltriethoxysilane, ethyltriisopropoxysilane, ethyltributoxysilane, butyltrimethoxysilane, phenyltrimethoxysilane, phenyltriethoxysilane, d³-methyltrimethoxysilane, n-propyltrimethoxysilane, n-propyltriethoxysilane, n-butyltriethoxysilane, n-hexyltrimethoxysilane, n-hexyltriethoxysilane, decyltrimethoxysilane, vinyltrimethoxysilane, vinyltriethoxysilane, 3-methacryloxypropyltrimethoxysilane, 3-methacryloxypropyltriethoxysilane, 3-acryloxypropyltrimethoxysilane, 3-acryloxypropyltriethoxysilane, p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, 3-aminopropyltrimethoxysilane, 3-aminopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, ((3-ethyl-3-oxetanyl)methoxy)propyltrimethoxysilane, ((3-ethyl-3-oxetanyl)methoxy)propyltriethoxysilane, 3-mercaptopropyltrimethoxysilane, and 3-trimethoxysilylpropylsuccinic acid; as the difunctional silane compound, dimethyldiacetoxysilane, dimethyldimethoxysilane, diphenyldimethoxysilane, diphenyldiethoxysilane, diphenyldiphenoxysilane, dibutyldimethoxysilane, dimethyldiethoxysilane, (3-glycidoxypropyl)methyldimethoxysilane, (3-glycidoxypropyl)methyldiethoxysilane, 3-(2-aminoethylamino)propyldimethoxymethylsilane, 3-aminopropyldiethoxymethylsilane, 3-mercaptopropyldimethoxymethylsilane, cyclohexyldimethoxymethylsilane, diethoxymethylvinylsilane, dimethoxymethylvinylsilane, and dimethoxydi-p-tolylsilane; and as the monofunctional silane compound, trimethylsilane, tributylsilane, trimethylmethoxysilane, tributylethoxysilane, (3-glycidoxypropyl)dimethylmethoxysilane, and (3-glycidoxypropyl)dimethylethoxysilane.

Preferred among the tetrafunctional silane compounds are tetramethoxysilane, tetraethoxysilane, and tetrabutoxysilane; preferred among the trifunctional silane compounds are methyltrimethoxysilane, methyltriethoxysilane, methyltriisopropoxysilane, methyltributoxysilane, phenyltrimethoxysilane, ethyltrimethoxysilane, ethyltriethoxysilane, ethyltriisopropoxysilane, ethyltributoxysilane, butyltrimethoxysilane, 3-glycidoxypropyltrimethoxysilane, 3-glycidoxypropyltriethoxysilane, 2-(3,4-epoxycyclohexyl)ethyltrimethoxysilane, and 2-(3,4-epoxycyclohexyl)ethyltriethoxysilane; preferred among the difunctional silane compounds are dimethyldimethoxysilane, diphenyldimethoxysilane, diphenyldiethoxysilane, diphenyldiphenoxysilane, dibutyldimethoxysilane, and dimethyldiethoxysilane.

These silane compounds may be used alone or in combination of two or more thereof.

The photosensitive resin composition may comprise the silane compound in an amount of 0 to 50 parts by weight, or 3 to 12 parts by weight, based on 100 parts by weight of the acrylic copolymer (A) (on the basis of solids content excluding solvents). Within the above content range, the chemical resistance of a cured film to be formed may be further enhanced.

In addition, the positive-type photosensitive resin composition of the present invention may comprise other additives such as an antioxidant and a stabilizer as long as the physical properties of the colored photosensitive resin composition are not adversely affected.

Further, the present invention provides a cured film formed from the positive-type photosensitive resin composition.

The cured film may be formed by a method known in the art, for example, a method in which the photosensitive resin composition is coated on a substrate and then cured.

More specifically, in the curing step, the photosensitive resin composition coated on a substrate may be subjected to pre-bake at a temperature of, for example, 60 to 130° C. to remove solvents; then exposed to light using a photomask having a desired pattern; and subjected to development using a developer, for example, a tetramethylammonium hydroxide (TMAH) solution to form a pattern on the coating layer. Thereafter, the patterned coating layer, if necessary, is subjected to post-bake, for example, at a temperature of 150 to 300° C. for 10 minutes to 5 hours to prepare a desired cured film. The exposure to light may be carried out at an exposure rate of 10 to 200 mJ/cm², or 10 to 300 mJ/cm², based on a wavelength of 365 nm in a wavelength band of 200 to 500 nm. According to the process of the present invention, it is possible to easily form a desired pattern from the viewpoint of the process.

The coating of the photosensitive resin composition onto a substrate may be carried out by a spin coating method, a slit coating method, a roll coating method, a screen printing method, an applicator method, or the like, in a desired thickness of, e.g., 2 to 25 μm. In addition, as a light source used for the exposure (irradiation), a low-pressure mercury lamp, a high-pressure mercury lamp, an extra high-pressure mercury lamp, a metal halide lamp, an argon gas laser, or the like may be used. X-ray, electronic ray, or the like may also be used, if desired.

Meanwhile, the photosensitive resin composition may be subjected to photobleaching at an energy of 300 to 2,000 mJ/cm² or 500 to 1,500 mJ/cm² after the exposure to light and development to obtain a more transparent cured film Specifically, the composition may be coated on a substrate and subjected to the exposure to light and development steps, followed by photobleaching and hard-bake thereof to form a cured film. The photobleaching step removes the N₂ bonds of the 1,2-quinonediazide-based compound, which is one of the major components of the positive-type photosensitive resin composition, thereby forming a transparent cured film. If the hard-bake is carried out without the photobleaching step, a reddish cured film is obtained, so that the transmittance in the region of, for example, 400 to 600 nm is deteriorated.

The positive-type photosensitive resin composition of the present invention is capable of forming a cured film having little thermal flowability, excellent appearance characteristics without a rough surface of the film and scum or the like, and further enhanced sensitivity.

In particular, the cured film may have a sensitivity of 50 to 140 mJ/cm², 50 to 130 mJ/cm², 60 to 130 mJ/cm², or 70 to 130 mJ/cm² at a thickness of 3.5 μm.

In addition, as described above, when the cured film is prepared by coating the positive-type photosensitive resin composition on a substrate and thermally drying it to form a dry film, followed by development and hard-bake thereof, the difference in line size (i.e., CD size) of the hole pattern formed in the cured film may be 0.01 to 0.1 μm, 0.01 to 0.08 μm, or 0.05 to 0.08 μm, with respect to a mask size of 11 μm before and after the hard-bake step. Within the above range, the thermal flow does not occur in the composition, whereby it is possible to achieve more excellent pattern developability and sensitivity.

As described above, the positive-type photosensitive resin composition introduces a multifunctional monomer into a positive-type photosensitive resin composition comprising a mixed binder in which a siloxane copolymer is added to an acrylic copolymer, whereby the penetration of a developer into the binder can be facilitated at the time of development of a pre-baked film to increase the solubility in the developer, thereby further enhancing the pattern developability and sensitivity. In addition, a cured film with little thermal flowability can be obtained if the composition is used. Further, a cured film prepared from the composition may have excellent appearance characteristics without a rough surface of the film and a scum or the like at the bottom of the film during development. Thus, the cured film prepared therefrom can be advantageously used in a liquid crystal display, an organic EL display, and the like.

### Mode for the Invention

Hereinafter, the present invention will be described in more detail with reference to the following examples. However, these examples are provided to illustrate the present invention, and the scope of the present invention is not limited thereto only. In the following preparation examples, the weight average molecular weight is determined by gel permeation chromatography (GPC, eluent: tetrahydrofuran) referenced to a polystyrene standard.

### EXAMPLE

### Preparation Example 1: Preparation of an Acrylic Copolymer (A-1)

A flask equipped with a cooling tube and a stirrer was charged with 200 parts by weight of methyl 3-methoxypropionate (MMP) as a solvent, and the temperature of the solvent was raised to 70° C. while it was slowly stirred. Subsequently, added thereto were 19.8 parts by weight of styrene (Sty), 25.7 parts by weight of methyl methacrylate (MMA), 27.1 parts by weight of glycidyl methacrylate (GMA), 15.6 parts by weight of methacrylic acid (MAA), and 11.7 parts by weight of methyl acrylate (MA). Next, 3 parts by weight of 2,2′-azobis(2,4-dimethylvaleronitrile) as a radical polymerization initiator was added thereto dropwise over 5 hours to carry out a polymerization reaction. The weight average molecular weight of the copolymer thus obtained (solids content: 32% by weight) was 9,000 to 11,000 Da.

### Preparation Examples 2 to 4: Preparation of Acrylic Copolymers (A-2 to A-4)

Acrylic copolymers (A-2 and A-4) were prepared in the same manner as in Preparation Example 1, except that the kinds and/or the contents of the monomers were changed as shown in Table 1 below.

TABLE 1

| Acrylic | | | | | | | | Solids | |
|---|---|---|---|---|---|---|---|---|---|
| copolymer | | | | | | CH | | content | M.W. |
| (part by wt.) | Sty | MAA | GMA | MMA | MA | epoxy | CHMI | (% by wt.) | (Da) |
| A-1 | 19.8 | 15.6 | 27.1 | 25.7 | 11.7 | 0 | 0 | 32 | 9.000 to |
| | | | | | | | | | 11,000 |
| A-2 | 19.8 | 13.9 | 27.0 | 27.6 | 11.7 | 0 | 0 | 32 | 9.000 to |
| | | | | | | | | | 11,000 |
| A-3 | 18.8 | 15.5 | 0 | 28.0 | 11.1 | 26.6 | 0 | 32 | 9.000 to |
| | | | | | | | | | 11,000 |
| A-4 | 17.6 | 17.5 | 0 | 14.4 | 10.4 | 24.9 | 15.2 | 32 | 9.000 to |
| | | | | | | | | | 11,000 |

CH epoxy: 3,4-epoxycyclohexylmethyl methacrylate
CHMI: N-cyclohexylmaleimide

### Preparation Example 1: Preparation of a Siloxane Copolymer (B-1)

To a reactor equipped with a reflux condenser, 20% by weight of phenyltrimethoxysilane (PhTMOS), 30% by weight of methyltrimethoxysilane (MTMOS), 20% by weight of tetraethoxysilane (TEOS), and 15% by weight of deionized water (DI water) were added, and then 15% by weight of PGMEA was added thereto. Then, the mixture was vigorously stirred while refluxed in the presence of 0.1% by weight of an oxalic acid catalyst for 6 hours. Then, the mixture was cooled and diluted with PGMEA such that the solids content was 30% by weight, thereby obtaining a siloxane copolymer (B-1). The weight average molecular weight of the copolymer thus obtained (solids content: 30% by weight) was 6,000 to 11,000 Da.

In addition, when the copolymer thus obtained was pre-baked at about 100° C. and then dissolved in an aqueous solution of 1.5% by weight of tetramethylammonium hydroxide, the average dissolution rate (ADR) was 4,113 Å/sec.

### Preparation Examples 6 to 9: Preparation of Siloxane Copolymers (B-2 to B-5)

Siloxane copolymers (B-2 and B-5) were prepared in the same manner as in Preparation Example 1, except that the kinds and/or the contents of the monomers were changed as shown in Table 2 below.

TABLE 2

| | | | | | | ADR | Solids | |
|---|---|---|---|---|---|---|---|---|
| Siloxane | | | | | | (1.5% | content | |
| copolymer | | | | DI | | TMAH; | (% by | M.W. |
| (% by wt.) | PhTMOS | MTMOS | TEOS | water | PGMEA | Å/sec) | wt.) | (Da) |
| B-1 | 20 | 30 | 20 | 15 | 15 | 4,113 | 30 | 6.000 to |
| | | | | | | | | 11,000 |
| B-2 | 20 | 30 | 20 | 15 | 15 | 143 | 30 | 6.000 to |
| | | | | | | | | 11,000 |
| B-3 | 20 | 30 | 20 | 15 | 15 | 1,576 | 30 | 6.000 to |
| | | | | | | | | 11,000 |
| B-4 | 20 | 30 | 20 | 15 | 15 | 3,232 | 30 | 6.000 to |
| | | | | | | | | 11,000 |
| B-5 | 20 | 30 | 20 | 15 | 15 | 4,743 | 30 | 6.000 to |
| | | | | | | | | 11,000 |

### Preparation Example 10: Preparation of an Epoxy Compound (F)

A three-necked flask was equipped with a cooling tube and placed on a stirrer equipped with a thermostat. The flask was charged with 100 parts by weight of a monomer composed of 100% by mole of cyclohexylmethyl methacrylate, 10 parts by weight of 2,2′-azobis(2-methylbutyronitrile), and 100 parts by weight of propylene glycol monomethyl ether acetate (PGMEA), followed by charging nitrogen thereto. Thereafter, the temperature of the solution was raised to 80° C. while the solution was slowly stirred, and the temperature was maintained for 5 hours. Then, PGMEA was added such that the solids content was 20% by weight, thereby obtaining an epoxy compound having a weight average molecular weight of 3,000 to 6,000 Da.

### Examples and Comparative Examples: Preparation of Positive-Type Photosensitive Resin Compositions

The photosensitive resin compositions of the following Examples and Comparative Examples were each prepared using the compounds prepared in the above Preparation Examples.

The components used in the following Examples and Comparative Examples are as follows.

TABLE 3

| | | | | Solids |
|---|---|---|---|---|
| | | | | content (% |
| Component | | Compound and/or brand name | Manufacturer | by weight) |
| Acrylic copolymer | A-1 | Preparation Example 1 | — | 32 |
| (A) | A-2 | Preparation Example 2 | — | 32 |
| | A-3 | Preparation Example 3 | — | 32 |
| | A-4 | Preparation Example 4 | — | 32 |
| Siloxane | B-1 | Preparation Example 5 | — | 30 |
| copolymer (B) | B-2 | Preparation Example 6 | — | 30 |
| | B-3 | Preparation Example 7 | — | 30 |
| | B-4 | Preparation Example 8 | — | 30 |
| | B-5 | Preparation Example 9 | — | 30 |
| 1,2- | C-1 | TPA-523 | Miwon | 100 |
| quinonediazide | C-2 | 1MC (MCAD-1040) | Shinryo Corp. | 100 |
| compound (C) | C-3 | THA-523 | Miwon | 100 |
| Multifunctional | D-1 | Dipentaerythritol | Nippon Kayaku | 100 |
| monomer (D) | | hexa(meth)acrylate (DPHA) | | |
| | D2 | 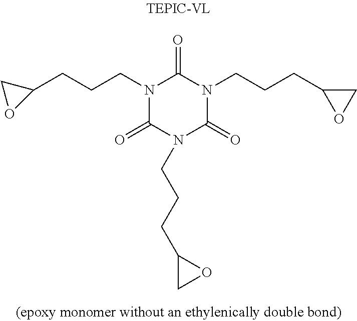 [SMILES: O=c1n(CCCC2CO2)c(=O)n(CCCC2CO2)c(=O)n1CCCC1CO1] | Nissan Chemical | 100 |
| | D-3 | T-1420 | Nippon Kayaku | 100 |
| | D-4 | DPCA-30 | Nippon Kayaku | 100 |
| Solvent (E) | E-1 | Propylene glycol monomethyl | Chemtronix | — |
| | | ether acetate (PGMEA) | | |
| | E-2 | Methyl 3-methoxypropionate | Chemtronix | — |
| | | (MMP) | | |
| | E-3 | Diethylene glycol methyl ethyl | Chemtronix | — |
| | | ethyl (MEDG) | | |

| | | | |
|---|---|---|---|
| Epoxy compound (F) | Preparation Example 10 | — | 20 |
| Surfactant (G) | Silicone-based leveling | Dow Corning | 100 |
| | surfactant, FZ-2122 | Toray | |

### Example 1: Preparation of a Photosensitive Resin Composition

A reactor was charged with 22.50% by weight and 28.32% by weight of the acrylic copolymers (A-1) and (A-2) of Preparation Examples 1 and 2, respectively, based on the total weight of the photosensitive resin composition excluding the solvents in a balanced amount. In addition, charged thereto were 57.33 parts by weight of the siloxane copolymer (B-1) of Preparation Example 5, 6.53 parts by weight of the epoxy compound (F) of Preparation Example 10, 5.90 parts by weight of the multifunctional monomer (D-1), and 15.30 parts by weight and 11.36 parts by weight of the 1,2, quinonediazide compounds (C-1) and (C-2), respectively, based on 100 parts by weight of the acrylic copolymer (A) (on the basis of solids content). Further, 0.23% by weight of the surfactant was added based on the total weight of the composition. Then, 45.24% by weight of the solvent (E-1), 24.96% by weight of the solvent (E-2), and 7.80% by weight of the solvent (E-3) were mixed therewith such that the solids content was 22% by weight. After 3 hours, the mixed solution was filtered through a membrane filter having a pore size of 0.2 μm to obtain a composition solution having a solids content of 22% by weight.

### Examples 2 to 10 and Comparative Examples 1 to 4: Preparation of Photosensitive Resin Compositions

Photosensitive resin composition solutions were each prepared in the same manner as in Example 1, except that the kinds and/or contents of the respective components were changed as shown in Tables 4 and 5 below.

TABLE 4

| % by | | | | | | | | | |
|---|---|---|---|---|---|---|---|---|---|
| wt./part by | Acrylic copolymer (A) | | | | Siloxane copolymer (B) | | | | |
| wt. | A-1 | A-2 | A-3 | A-4 | B-1 | B-2 | B-3 | B-4 | B-5 |
| Ex. 1 | 22.50 | 28.32 | — | — | 57.33 | — | — | — | — |
| Ex. 2 | 22.23 | 28.00 | — | — | 57.29 | — | — | — | — |
| Ex. 3 | 21.95 | 27.64 | — | — | 57.29 | — | — | — | — |
| Ex. 4 | 21.95 | 27.64 | — | — | — | 57.29 | — | — | — |
| Ex. 5 | 21.95 | 27.64 | — | — | — | — | 57.29 | — | — |
| Ex. 6 | 21.95 | 27.64 | — | — | — | — | — | 57.29 | — |
| Ex. 7 | 21.95 | 27.64 | — | — | — | — | — | — | 57.29 |
| Ex. 8 | 21.95 | 27.64 | — | — | 57.29 | — | — | — | — |
| Ex. 9 | 22.50 | 28.32 | — | — | 57.33 | — | — | — | — |
| Ex. 10 | 22.50 | 28.32 | — | — | 57.33 | — | — | — | — |
| C. Ex. 1 | 23.32 | 29.36 | — | — | 57.20 | — | — | — | — |
| C. Ex. 2 | — | — | 56.77 | 25.45 | — | — | — | — | — |
| C. Ex. 3 | — | — | 53.45 | 23.91 | — | — | — | — | — |
| C. Ex. 4 | 21.95 | 27.64 | — | — | 57.29 | — | — | — | — |

TABLE 5

| | | | | | | | | Epoxy | | | | |
|---|---|---|---|---|---|---|---|---|---|---|---|---|
| % by | 1,2-quinonediazide | | | | | | | comp’d | Surfactant | | | |
| wt./part | compound (C) | | | Multifunctional monomer (D) | | | | (F) | (G) | Solvent (E) | | |
| by wt. | C-1 | C-2 | C-3 | D-1 | D-2 | D-3 | D-4 | B-4 | B-5 | E-1 | E-2 | E-3 |
| Ex. 1 | 15.30 | 11.36 | — | 5.90 | — | — | — | 6.53 | 0.23 | 45.24 | 24.96 | 7.80 |
| Ex. 2 | 15.48 | 11.49 | — | 7.96 | — | — | — | 6.52 | 0.23 | 45.24 | 24.96 | 7.80 |
| Ex. 3 | 15.67 | 11.64 | — | 10.08 | — | — | — | 6.60 | 0.23 | 45.24 | 24.96 | 7.80 |
| Ex. 4 | 15.67 | 11.64 | — | 10.08 | — | — | — | 6.60 | 0.23 | 45.24 | 24.96 | 7.80 |
| Ex. 5 | 15.67 | 11.64 | — | 10.08 | — | — | — | 6.60 | 0.23 | 45.24 | 24.96 | 7.80 |
| Ex. 6 | 15.67 | 11.64 | — | 10.08 | — | — | — | 6.60 | 0.23 | 45.24 | 24.96 | 7.80 |
| Ex. 7 | 15.67 | 11.64 | — | 10.08 | — | — | — | 6.60 | 0.23 | 45.24 | 24.96 | 7.80 |
| Ex. 8 | 15.67 | — | 11.64 | 10.08 | — | — | — | 6.60 | 0.23 | 45.24 | 24.96 | 7.80 |
| Ex. 9 | 15.30 | 11.36 | — | — | — | 5.90 | — | 6.53 | 0.23 | 45.24 | 24.96 | 7.80 |
| Ex. 10 | 15.30 | 11.36 | — | — | — | — | 5.90 | 6.53 | 0.23 | 45.24 | 24.96 | 7.80 |
| C. Ex. 1 | 14.75 | 10.96 | — | — | — | — | — | 6.56 | 0.23 | 45.24 | 24.96 | 7.80 |
| C. Ex. 2 | 8.40 | — | 9.84 | — | — | — | — | 3.10 | 0.23 | 72.54 | 5.46 | — |
| C. Ex. 3 | 8.93 | — | 10.46 | 6.46 | — | — | — | 3.11 | 0.23 | 72.54 | 5.46 | — |
| C. Ex. 4 | 15.67 | 11.64 | — | — | 10.08 | — | — | 6.60 | 0.23 | 45.24 | 24.96 | 7.80 |

### EVALUATION EXAMPLE

### Evaluation Example 1: Film Retention Rate

The compositions prepared in the Examples and the Comparative Examples were each coated onto a glass substrate by spin coating. The coated substrate was then pre-baked on a hot plate kept at 105° C. for 105 seconds to form a dry film. It was then developed with an aqueous developer of 2.38% by weight of tetramethylammonium hydroxide through puddle nozzles at 23° C. for 85 seconds. Thereafter, the developed film was subjected to photobleaching by exposing it to light at an exposure rate of 200 mJ/cm² based on a wavelength of 365 nm for a certain time period using an aligner (model name: MA6) that emits light having a wavelength of 200 nm to 450 nm. The exposed film thus obtained was heated in a convection oven at 240° C. for 20 minutes to prepare a cured film having a thickness of 2.1 μm. The film retention rate (%) was obtained from the following equation by calculating the ratio in a percent of the thickness of the film upon the post-bake to that of the film upon the pre-bake by using a measuring instrument (SNU Precision). The film retention rate was evaluated as excellent for 70% or more and good for 60% to less than 70%.

Film retention rate (%)=(film thickness upon post-bake/film thickness upon pre-bake)×100 [Equation]

### Evaluation Example 2: Sensitivity

The compositions prepared in the Examples and the Comparative Examples were each coated onto a glass substrate by spin coating. The coated substrate was then pre-baked on a hot plate kept at 105° C. for 105 seconds to form a dry film A mask having a pattern of square holes in a size ranging from 1 μm to 30 μm was placed on the dried film. The film was then exposed to light at an exposure rate of 0 to 200 mJ/cm² based on a wavelength of 365 nm for a certain time period using an aligner (model name: MA6) that emits light having a wavelength of 200 nm to 450 nm. Here, an i-line optical filter was applied, and the spacing between the exposure reference mask and the substrate was maintained at 20 μm. It was then developed for 85 seconds with a developer, which was an aqueous solution of 2.38% by weight of tetramethylammonium hydroxide, through puddle nozzles at 23° C.

Thereafter, the developed film was subjected to photobleaching by exposing it to light at an exposure rate of 200 mJ/cm² based on a wavelength of 365 nm for a certain time period using an aligner (model name: MA6) that emits light having a wavelength of 200 nm to 450 nm. The exposed film thus obtained was heated in a convection oven at 240° C. for 20 minutes to prepare a cured film having a thickness of 3.5 μm (i.e., hard-bake step).

For the hole pattern formed per a mask size of 11 μm through the above process, the amount of exposure energy (mJ/cm²) for attaining a critical dimension (CD, unit: μm) of 10 μm was measured. The lower the exposure energy, the better the sensitivity.

### Evaluation Example 3: Thermal Flowability

A cured film was obtained in the same manner as in Evaluation Example 2.

In such event, the critical dimension (CD, unit: μm) of the hole pattern formed for the mask size 11 μm before and after the curing was measured, respectively. The thermal flowability was evaluated from the difference (i.e., the difference in the critical dimension of the hole pattern formed in the cured film before and after the hard-bake step) according to the following criteria.
0.1 μm or less: no thermal flowability (excellent)
Greater than 0.1 μm to 0.3 μm: slight thermal flowability (good)
Greater than 0.3: high thermal flowability (poor)

### Evaluation Example 4: Scum

A cured film was obtained in the same manner as in Evaluation Example 2. It was exposed to light such that the critical dimension was 10 μm for the hole pattern formed per a mask size of 11 μm. Then, the cross-section of the hole pattern was observed by SEM to confirm the presence of scum. The less the scum, the better. If scum was not present, [symbol] ” If scum was, “∘.” If a lot of scum was present, “⊚.”

### Evaluation Example 5: Surface Roughness

A cured film was obtained in the same manner as in Evaluation Example 2. The surface of the prepared cured film was observed by SEM, and the degree of defects such as irregularities and cracks on the surface was numerically evaluated as 1 to 5. The closer to 1, the better the surface roughness.

TABLE 6

| | Film | | Thermal | | |
|---|---|---|---|---|---|
| | retention | Sensitivity | flowability | | Surface |
| | rate (%) | (mJ/cm²) | (μm) | Scum | roughness |
| Ex. 1 | 72.6 | 102 | 0.05 | X | 2 |
| Ex. 2 | 68.5 | 93 | 0.06 | X | 2 |
| Ex. 3 | 67.8 | 85 | 0.09 | X | 1 |
| Ex. 4 | 73.6 | 125 | 0.06 | X | 2 |
| Ex. 5 | 66.1 | 104 | 0.08 | X | 1 |
| Ex. 6 | 62.6 | 94 | 0.05 | X | 1 |
| Ex. 7 | 61.9 | 76 | 0.06 | X | 1 |
| Ex. 8 | 65.2 | 80 | 0.06 | X | 1 |
| Ex. 9 | 71.1 | 110 | 0.08 | X | 2 |
| Ex. 10 | 83.2 | 128 | 0.08 | X | 2 |
| C. Ex. 1 | 78.1 | 143 | 0.07 | ◯ | 5 |
| C. Ex. 2 | 78.4 | 210 | 0.15 | ◯ | 5 |
| C. Ex. 3 | 67.9 | 178 | 0.62 | X | 2 |
| C. Ex. 4 | 72.2 | 122 | 0.06 | ⊚ | 3 |

As shown in Table 6, the cured films prepared from the compositions of the Examples falling within the scope of the present invention had excellent sensitivity and small differences in the critical dimension between before and after the curing, indicating that little heat flow occurred (i.e., excellent thermal flowability). In addition, no scum was found on the cross-section of the hole pattern, and the appearance characteristics were also excellent as the surface roughness was good or excellent.

In contrast, in the cured films prepared from the compositions of Comparative Examples 1 and 2 (not comprising a multifunctional monomer), the sensitive was inferior to that of the Examples, scum was found on the cross-section of the hole pattern, and a lot of defects such as irregularities and cracks were found on the surface, resulting in poor surface roughness. In addition, in the cured film prepared from the composition of Comparative Example 3 (not comprising a siloxane compound), the appearance characteristics (e.g., scum occurrence and surface roughness) were equivalent to those of the Examples, whereas the thermal flow was a lot (i.e., poor thermal flowability) and the sensitivity was lower than that of the Examples. Further, in the cured film prepared from the composition of Comparative Example 4 (comprising an epoxy monomer), the surface roughness was very poor; in particular, a lot of scum was found in the hole pattern. It was confirmed from the above that although the developability can be improved by introducing a small monomer such as an epoxy monomer, the surface roughness and scum in a pattern cannot be improved when an epoxy group, instead of a double bond, is introduced as a functional group.

1. A positive-type photosensitive resin composition, which comprises:
(A) an acrylic copolymer;
(B) a siloxane copolymer;
(C) a 1,2-quinonediazide compound;
(D) a multifunctional monomer; and
(E) a solvent.

2. The positive-type photosensitive resin composition of claim 1, which comprises the multifunctional monomer (D) in an amount of 1 to 30 parts by weight based on 100 parts by weight of the acrylic copolymer (A).

3. The positive-type photosensitive resin composition of claim 1, wherein the multifunctional monomer (D) is a tri- to octa-functional compound.

4. The positive-type photosensitive resin composition of claim 1, wherein the multifunctional monomer (D) contains an ethylenically unsaturated double bond.

5. The positive-type photosensitive resin composition of claim 1, wherein the acrylic copolymer (A) comprises (a-1) a structural unit derived from an ethylenically unsaturated carboxylic acid, an ethylenically unsaturated carboxylic anhydride, or a combination thereof; (a-2) a structural unit derived from an unsaturated compound containing an epoxy group; and (a-3) a structural unit derived from an ethylenically unsaturated compound different from the structural units (a-1) and (a-2).

6. The positive-type photosensitive resin composition of claim 5, wherein the structural unit (a-3) comprises a structural unit (a-3-1) represented by the following Formula 1: 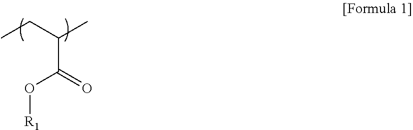
in the above Formula 1, R₁ is C₁₋₄ alkyl.

7. The positive-type photosensitive resin composition of claim 6, wherein the structural unit (a-3) comprises a structural unit (a-3-2) represented by the following Formula 2: 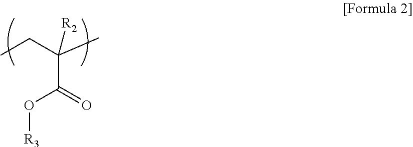
in the above Formula 2, R₂ and R₃ are each independently C₁₋₄ alkyl.

8. The positive-type photosensitive resin composition of claim 7, wherein the structural unit (a-3-1) and the structural unit (a-3-2) have a content ratio of 1:99 to 80:20.

9. The positive-type photosensitive resin composition of claim 1, wherein the siloxane copolymer (B) comprises a structural unit derived from a silane compound represented by the following Formula 3:
(R₄)ₙSi(OR₅)₄₋ₙ [Formula 3]
in the above Formula 3,
n is an integer of 0 to 3;
R₄ is each independently C₁₋₁₂ alkyl, C₂₋₁₀ alkenyl, C₆₋₁₅ aryl, C₃₋₁₂ heteroalkyl, C₄₋₁₀ heteroalkenyl, or C₆₋₁₅ heteroaryl; and
R₅ is each independently hydrogen, C₁₋₆ alkyl, C₂₋₆ acyl, or C₆₋₁₅ aryl,
wherein the heteroalkyl, the heteroalkenyl, and the heteroaryl groups each independently have at least one heteroatom selected from the group consisting of O, N, and S.

10. The positive-type photosensitive resin composition of claim 1, which comprises the siloxane copolymer (B) in an amount of 20 to 80 parts by weight based on 100 parts by weight of the acrylic copolymer (A).

11. The positive-type photosensitive resin composition of claim 1, which further comprises an epoxy compound.

12. A cured film prepared from the positive-type photosensitive resin composition of claim 1.
